(19) United States
(12) Patent Application Publication
(10) Pub. No.: US 2026/0159236 A1
(43) Pub. Date: Jun. 11, 2026

(54) AIRCRAFT HAVING A FUEL-CELL PROPULSION SYSTEM

(71) Applicant: MTU Aero Engines AG, München (DE)

(72) Inventors: Thomas Scherer, Hamburg (DE); Barnaby Law, Starnberg (DE); Stephan Lellek, Garching (DE); Jan Hägert, Alling (DE)

(73) Assignee: MTU Aero Engines AG, München (DE)

(21) Appl. No.: 19/120,737

(22) PCT Filed: Oct. 16, 2023
(86) PCT No.: PCT/DE2023/100768

§ 371 Date: Apr. 11, 2025

(30) Foreign Application Priority Data
Oct. 28, 2022 (DE) 10 2022 128 715.7

(51) Int. Cl. B64C 29/04; B64C 1/00; B64D 27/34; B64D 27/355; B64D 33/10; B64D 37/04; H01M 8/04014; H01M 8/04029; H01M 8/04082

(52) U.S. Cl. CPC B64C 29/04; B64C 1/00; B64D 27/34; B64D 27/355; B64D 33/10; B64D 37/04; H01M 8/04014; H01M 8/04029; H01M 8/04201; H01M 2250/20

(57) ABSTRACT

The invention is directed to an aircraft having a fuel-cell propulsion system that includes a fuel cell for supplying electricity to an electric propulsion apparatus of the aircraft, a fuel store for storing fuel for the fuel cell, and a cooling apparatus for cooling the fuel cell. A main heat exchanger of the cooling apparatus and the fuel store are arranged on a top side of a fuselage of the aircraft, and the main heat exchanger is arranged in front of the fuel store toward the aircraft nose.

### BACKGROUND OF THE INVENTION

The invention relates to an aircraft having a fuel-cell propulsion system. The fuel-cell propulsion system has a fuel cell, a fuel store and a cooling apparatus.

The design of novel propulsion systems based on fuel cells differs significantly from conventional turbomachine propulsion of aircrafts. Fuel cells convert chemically bound energy from a fuel, particularly hydrogen, into electrical energy. At low temperatures, large quantities of waste heat are generated as a byproduct, which must be dissipated into the environment by means of a heat exchanger. Even the integration of these novel propulsion systems, such as the fuel-cell propulsion system, differs significantly from conventional propulsion systems. Storing the fuel and heat dissipation, the two aspects mentioned above, represent major integration challenges in the aircraft.

The large dimensions of heat exchangers make integration aerodynamically complex and generates significant flow resistance (drag).

### SUMMARY OF THE INVENTION

The object of the invention is to provide an aircraft with a fuel cell propulsion system, which integrates the components of the fuel-cell propulsion system in such a way that a drag of the aircraft at high usable volume is optimized.

The object is achieved by the subject matter of the independent patent claims. Advantageous embodiments of the invention are described in the dependent claims, the following description and the figures given below.

The invention provides an aircraft with a fuel-cell propulsion system. The fuel-cell propulsion system comprises at least one fuel cell for supplying electricity to an electric propulsion apparatus of the aircraft, at least one fuel store for storing fuel for the fuel cell, and at least one cooling apparatus for cooling the fuel cell. It is envisaged that the main heat exchanger of the cooling device and the fuel store are arranged on the top side of a fuselage of the aircraft, and the main heat exchanger is arranged on the nose side in front of the fuel store.

An aircraft can be understood, in particular, as an airplane. Furthermore, the aircraft can also be designed as a rotary-wing aircraft. In particular, the aircraft is heavier than air and has an electric propulsion apparatus.

The fuel cell of the fuel-cell propulsion system is designed to convert chemically bound energy of the fuel into electrical energy and thus supply the electric propulsion apparatus, which may, in particular, comprise at least one electric machine, for example an electric motor. Furthermore, the fuel cell can supply other systems of the aircraft with electrical energy. The electric machine can, in turn, propel at least one propelling means, for example a propeller, a fan, a rotor, or similar, to generate propulsion and/or lift.

The fuel, in particular hydrogen, can be stored in a fuel store, which can comprise at least one pressure tank, preferably of cylindrical shape. It is proposed that the fuel store is designed to be large enough to accommodate the desired maximum cruising range of the aircraft. Furthermore, it is proposed that the diameter and/or length of the pressure tank can be designed depending on the drag of an aircraft configuration.

The fuel can be supplied to the fuel cell via corresponding fuel lines connecting the fuel store and the fuel cell. Furthermore, the fuel cell may require oxygen, which can be supplied to the fuel cell from the ambient air by means of an air supply unit.

In addition to generating electrical energy, the fuel-cell propulsion system, in particular the fuel-cell, also dissipates a large amount of heat loss at low temperatures, for example, between 80° C. and 100° C. This heat loss must be dissipated to the environment via the cooling apparatus so that the fuel-cell propulsion system can be maintained at a desired operating temperature.

The cooling apparatus has at least one main heat exchanger. The main heat exchanger is provided and designed to dissipate the heat generated by the fuel-cell propulsion system to the environment, in particular to the ambient air. For example, the heat dissipated can be directed into the cooling fins or cooling plates of the main heat exchanger. The cooling fins can then preferably be cooled by forced convection by the ambient air.

In particular, the ambient air can have a temperature of −50° C. to 35° C., so that the main heat exchanger is preferably designed such that even at an ambient air temperature of 35° C., the main heat exchanger can provide an equivalent cooling capacity. In particular, due to a small difference in the temperature of the fuel-cell system compared to the ambient air, it can be envisaged that the main heat exchanger is designed sufficiently large to provide the required cooling capacity.

It is envisaged that the main heat exchanger and the fuel store are arranged on top of the aircraft's fuselage. The top can be understood as the top section of the fuselage when the aircraft is stationary or in a stationary horizontal flight. For example, the top can also be understood as the roof of the fuselage. In particular, with a round or oval cross-section of the fuselage, the top can be designed as an upper circular arc section, for example with an opening angle of the circular arc section in a range of 90° to 180°, preferably of 120°.

Furthermore, it is envisaged that the main heat exchanger is arranged on the nose side in front of the fuel store. In other words, the main heat exchanger is arranged closer to a bow or nose of the aircraft in relation to the fuel store, with the fuel store being arranged closer to the rear of the aircraft. The nose represents, in particular a front part of the aircraft in a primary flight direction of the aircraft, whereas the rear represents a rear part of the aircraft in the primary flight direction. In other words, the main heat exchanger is arranged further forward or is in front of the fuel store. The fuel store is conceptually arranged “in the slipstream” of the main heat exchanger.

Among other things, the invention has the advantage that the drag can be significantly reduced through the combined integration of the main heat exchanger and the fuel store on the roof. This advantageously increases the overall efficiency of the aircraft.

Furthermore, it can be considered as advantageous that the present invention essentially requires no space within the fuselage. Since the fuselage essentially represents the usable space of the aircraft, it can be used without restriction and with maximum utilization for a payload or passengers.

A further advantage of the present invention is that the main heat exchanger and the energy store on the top side of the fuselage can be variably dimensioned and configured essentially without restrictions irrespective of the aerodynamic and flight properties of the aircraft, since they do not conflict spatially with other systems of the aircraft on the top side of the fuselage.

Compared to an arrangement where the heat exchanger is on an aircraft wing, particularly within an engine nacelle, the engine nacelle can be significantly reduced in size. From an aerodynamic perspective, this advantageously improves the airflow around the wing.

Furthermore, the invention improves the integration of the cooling apparatus. Both the fuel store and the heat exchanger must be connected via coolant pipes. The spatial proximity of the two components ensures a reduced overall length of the coolant pipes, thus reducing the structural weight of the fuel-cell propulsion system.

Furthermore, it is advantageous that the original structure of the aircraft can remain largely unchanged, thus significantly simplifying the integration of the fuel-cell propulsion system into the aircraft. The integration of the fuel-cell propulsion system can be achieved solely by modifying the top side of the fuselage or the wing. Accordingly, it can be envisaged that the fuel-cell propulsion system can be integrated into an existing aircraft model.

By arranging the fuel store on the roof, most of the fuel-conducting pipes can also be positioned on top of the aircraft. In the event of a fuel leak, especially hydrogen, a safe leak path is ensured, as the hydrogen can escape upwards. This significantly increases the safety of the overall system.

In one embodiment it is envisaged that the main heat exchanger and the fuel store are compactly arranged next to one another as an aerodynamic unit, in particular compactly in a longitudinal direction of the aircraft. An aerodynamic unit can be understood as an arrangement in which the main heat exchanger and the fuel store are dimensioned as close to each other as possible and matched with one another externally, so that they can fit together. In other words, an overall height and/or overall width of the main heat exchanger essentially corresponds to the overall height and/or overall width of the fuel store. Space between the main heat exchanger and the fuel store is preferably minimized, so that the fuel store is located virtually in the slipstream of the main heat exchanger.

This compact design is particularly advantageous for the aircraft's aerodynamics, as the ambient air flowing around it can only swirl minimally between the main heat exchanger and the energy store. Furthermore, the frontal area exposed to the airflow and the wetted surface of the aircraft can be advantageously reduced.

In one embodiment, it is envisaged that the aircraft comprises a streamlined cowl that encloses both the main heat exchanger and the fuel store. In other words, the cowl forms a housing for the main heat exchanger and the fuel store on the top, front, and rear sides, so that the main heat exchanger and the fuel store are arranged in a space enclosed by the top side of the fuselage and the cowl. The cowl is designed to be streamlined. This means that the cowl has a shape that minimizes the aerodynamic drag of the cowl relative to the surrounding ambient air. In particular, the cowl can be arranged on the fuselage in such a way that the drag in a transition region between the fuselage and the cowl is minimized. In other words, the top side of the cowl can be substantially convex and it curves along the fuselage. Preferably, the main heat exchanger can be structurally integrated in the front section of the cowl.

Among other things, the cowl offers the advantage of significantly reducing the drag of the main heat exchanger and the fuel store. Furthermore, the cowl can protect the main heat exchanger and the fuel store from external influences, such as weather.

In one embodiment it is envisaged that the cowl has an inlet opening on the nose side for admitting ambient air into the main heat exchanger. Preferably, the cowl has an outlet opening for discharging the ambient air from the cowl. In particular, the inlet opening of the cowl and the inlet of the main heat exchanger can be formed as a common unit.

In this context, nose side can be understood, in particular, as a front part of the cowl in the primary direction of flight of the aircraft, in particular a front section of the cowl. Accordingly, it is envisaged that the front of the cowl has the inlet opening.

In particular, the ambient air can flow into the main heat exchanger via the inlet opening and absorb heat. The ambient air can flow out of the main heat exchanger via an outlet of the main heat exchanger and preferably leave the cowl via the outlet opening. The cowl preferably has a plurality of outlet openings.

A nose-side inlet opening proves to be advantageous during aircraft operation, particularly in the main flight direction, since the ambient air flowing around the aircraft can flow aerodynamically favorably into the inlet opening in the main flow direction of the ambient air.

In one embodiment it is envisaged that the outlet opening is arranged in a discharge region of a surrounding ambient air flowing around the cowl. A discharge region can also be understood as a “wake space.” In the discharge region, the surrounding ambient air travels or lifts off a surface of the cowl. As a result, the ambient air swirls in the discharge region. This can have a negative impact on the aerodynamics of the cowl, in particular due to increased drag. In particular, the discharge region can be located in a rear section of the cowl.

Preferably, a discharge region or discharge regions on the cowl is or are identified, for example, by testing in a flow channel. An outlet opening can be specifically positioned in the known discharge region. Due to the air flowing out of the outlet opening the discharge region can be specifically energy-enriched or revitalized, thus counteracting a discharge of the surrounding ambient air. This can advantageously reduce drag and improve the aerodynamics of the cowl.

In one embodiment it is envisaged that the outlet is arranged in such a way that the ambient air released promotes a flow around a tail unit of the aircraft.

In particular, the tail unit can be positioned behind the fuselage or behind the main heat exchanger and fuel store, in the main flight direction. The improved airflow around the tail unit can advantageously enhance the stability and maneuverability of the aircraft.

In one embodiment it is envisaged that an air duct of the aircraft, in particular of the cooling apparatus in the cowl, fluidly connects an outlet of the main heat exchanger to the outlet opening of the cowl. In particular, the air duct or multiple air ducts can be configured to guide the ambient air streaming out of the outlet of the main heat exchanger in a targeted manner to the outlet opening or openings of the cowl, so that the air can be directed past the fuel store. This can prevent the heated air flowing out of the outlet of the main heat exchanger from swirling within the cowl and/or the heated air from dissipating heat within the cowl. Thus, high energy air can exit the cowl via the at least one air duct, i.e., with high kinetic and thermal energy.

In one embodiment it is envisaged that the fuel store comprises two cylindrical pressure tanks, the main extension direction of each of these pressure tanks being substantially parallel to a longitudinal axis of the aircraft. Preferably, the two cylindrical pressure tanks are arranged next to one another along the longitudinal axis. The main extension direction, in particular, can extend along a geometric height of the cylindrical shape of the pressure tank. In other words, the cylindrical pressure tanks can be horizontally arranged next to one another.

Two cylindrical pressure tanks of the fuel store can be advantageous as compared to a single fuel store of the same total capacity because this will result in reduced drag. This can increase the efficiency of the aircraft.

In one embodiment it is envisaged that the cooling apparatus has a secondary heat exchanger arranged in a downwash region of an aircraft propeller. In particular, the secondary heat exchanger can be dimensioned and designed several times smaller than the main heat exchanger. The secondary heat exchanger can be configured to provide the required cooling capacity during stationary operation of the aircraft with an active fuel-cell propulsion system and an active propulsion apparatus.

For example, during stationary operation, the main heat exchanger has a low cooling capacity, as no convective cooling is possible through the cooling fins or cooling plates of the main heat exchanger due to the lack of ambient airflow. According to this example, the bypass heat exchanger can provide a cooling capacity using the downwash of the propulsion unit, in particular the propeller, which can be designed for stationary operation of the fuel-cell propulsion system. This has the advantage that the cooling apparatus can provide sufficient cooling capacity in any operating situation of the aircraft.

In one embodiment it is envisaged that a liquid cooling medium of the cooling apparatus is configured to absorb waste heat from the fuel-cell and dissipate it into ambient air in the main heat exchanger. This has the advantage that the fuel-cell and the main heat exchanger can be arranged and operated spatially separate from one another.

Thus, an arrangement of the fuel-cell can be selected independently of the arrangement of the main heat exchanger, and vice versa.

The invention also includes combinations of the features of the described embodiments.

### BRIEF DESCRIPTION OF THE DRAWING FIGURES

The exemplary embodiments of the invention are described as follows:

FIG. 1 shows a perspective view of an aircraft with a fuel-cell propulsion system according to a preferred embodiment;

FIG. 2 shows a side view of an aircraft with a fuel-cell propulsion system according to a preferred embodiment.

The exemplary embodiment explained below is a preferred embodiment of the invention. In the exemplary embodiment, the described components of the embodiment each represent individual, independently considered features of the invention, which also further develop the invention independent of one another and are thus also to be considered as components of the invention, either individually or in combinations other than that shown. Furthermore, the described embodiment can also be supplemented by additional features of the invention already described.

In the figures, the same reference numbers indicate functionally identical elements.

### DESCRIPTION OF THE INVENTION

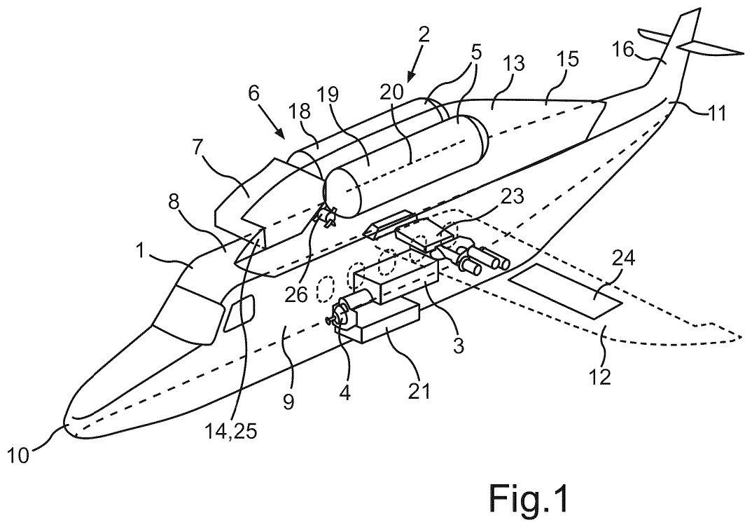

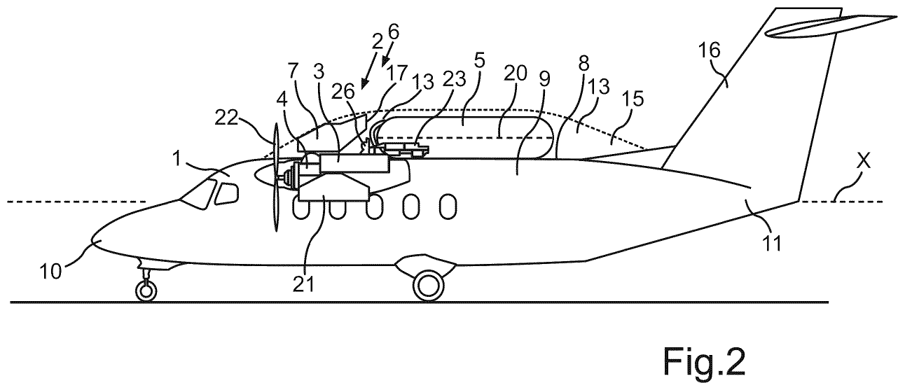

FIG. 1 shows a perspective view of an aircraft 1 with a fuel-cell propulsion system 2 according to a preferred embodiment. In FIG. 2 a side view of aircraft 1 is shown. The following description applies to both figures.

The aircraft 1 can, for example, be designed as an airplane 1, in particular as a conventional airplane 1 with a fuselage 9, a wing 12, and a tail unit 16 at the rear 11 of the airplane 1. For example, the aircraft 1 is designed as a twin-engine, shoulder-wing aircraft. Accordingly, the aircraft 1 can also be designed as a mid-wing, low-wing, flying wing, rotary-wing, or similar aircraft.

The fuel-cell propulsion system 2 of the airplane 1 can comprise at least one fuel-cell 3 for supplying electrical power to an electric propulsion apparatus 4 of the aircraft 1. For example, the fuel-cell 3 can be arranged together with the electric propulsion apparatus 4, in particular an electric motor, which can propel, for example, a propeller 22 (see FIG. 2) or a fan, in a nacelle below one of the wings 12.

The fuel-cell propulsion system 2 can further comprise a fuel store 5 for storing fuel for the fuel-cell 3. The fuel can, in particular, be hydrogen, which can be stored under high pressure, in particular in liquid form, in the fuel store 5. The fuel store 5 can, in particular, comprise at least one pressure tank, for example a first pressure tank 18 and a second pressure tank 19. The pressure tanks 18, 19 can be cylindrical and each have a main extension direction 20, wherein the main extension direction 20 can represent a geometric height of the cylindrical shape of the cylindrical pressure tanks 18, 19. In particular, the pressure tanks 18, 19 can be arranged parallel to one another in a horizontal plane and substantially parallel to a longitudinal axis X of the airplane 1.

The fuel store 5 is arranged in particular on the top side 8 of the fuselage 9 of the airplane 1. In other words, in this example, the pressure tanks 18, 19 of the fuel store 5 are located on a roof of the fuselage 9, so that a usable space within the fuselage 9 is not limited by the fuel store 5.

The fuel-cell propulsion system 2 may further comprise a cooling device 6 for cooling the fuel cell 3. The cooling device 6 may, for example, comprise a main heat exchanger 7, at least one secondary heat exchanger 21, a coolant tank 24, a coolant pump 26, and coolant pipes.

The main heat exchanger 7 is arranged on the top side 8 of the fuselage 9 of the aircraft 1, as well as on the nose side in front of the fuel store 5. “Nose side” means that the main heat exchanger 7 is arranged closer to a nose 10 of the airplane 1 than the fuel store 5. In particular, it can be envisaged that the main heat exchanger 7 of the fuel-cell propulsion system 2 must be dimensioned large compared to a heat exchanger of a conventional propulsion system with a heat engine, since the temperature of the fuel cell 3 is significantly lower than the temperature of a heat engine. Due to the required size of the main heat exchanger 7, positioning it on the roof of the airplane 1 is particularly aerodynamically advantageous.

For example, the main heat exchanger 7 and the fuel store 5 are compactly arranged next to one another as an aerodynamic unit, so that the aircraft aerodynamics can be improved. In particular, a cowl 13 of the main heat exchanger 7 and the fuel store 5 can thus be designed as a common cowl 13. The streamlined cowl 13, together with the top side 8 of the fuselage 9, forms a space in which the main heat exchanger 7 and the fuel store 5 are arranged. In particular, the cowl 13 has an aerodynamically advantageous shape. Further components, for example the coolant pump 26, coolant pipes, fuel pipes, or similar, can be arranged within the cowl 13.

Preferably, the cowl 13 forms an inlet opening 14 at its front, i.e., on the nose side, which can correspond to an inlet 25 of the main heat exchanger 7. During flight operation or forward travel of the airplane 1, the ambient air can thus flow into the inlet 25, aided by the flow of the ambient air, and in particular, by forced convection, extract heat from the cooling fins or cooling plates of the main heat exchanger 7.

The air flowing into the inlet 25 can flow out of an outlet 17 of the main heat exchanger 7. In particular, the outflowing air can be guided through air ducts in the cowl 13 around the pressure tanks 18, 19 to one or more outlet openings of the cowl 13. The outlet openings are preferably arranged in a discharge region 15 so that the outflowing air can energize a wake space of the discharge region 15. Alternatively or additionally, the outlet openings can be designed in such a way that a flow can be promoted around the tail unit 16.

Overall, the embodiment shows how the invention can be used to integrate a main heat exchanger and a fuel store unit in an aircraft in an aerodynamically advantageous manner.

The invention can provide a combined integration variant for the fuel store and a main heat exchanger on the roof of the aircraft. The combined integration of the two subsystems can significantly reduce the aircraft's drag and increase its overall efficiency. The voluminous pressure tanks are conceptually positioned in the “slipstream of the main heat exchanger.”

Unlike traditional integration variants, the fuel store is not located in the fuselage or on the wing, but on the roof of the aircraft. The cylindrical shape of the pressure tanks can be retained. Depending on the drag of the configuration, various diameters and lengths of the fuel store are conceivable. Furthermore, it is conceivable to divide a large pressure tank into two smaller pressure tanks. The diameter of these smaller pressure tanks can be significantly smaller, which reduces the storage efficiency. From an aerodynamic perspective, however, the division could result in significant advantages in drag, which can increase the efficiency of the entire airplane.

To further reduce the drag of this configuration, a cowl for the entire roof installation can be envisaged. The main heat exchanger, cooling apparatus, or thermal system, is structurally integrated into the front of this cowl. By locating the main heat exchanger on the roof, the engine nacelle on the wing can be significantly reduced in size. From an aerodynamic perspective, this can improve the airflow around the wing. Combining the fuel store and main heat exchanger in a cowl can reduce both the frontal area exposed to the airflow and the wetted surface of the airplane. As a result, the airplane's drag can be optimized.

Other advantages of the combined integration of tank and heat exchanger on the roof are the following: First, the integration of the cooling system is improved. Both the tank and the heat exchanger must be connected via coolant pipes. The spatial proximity of both components allows the overall length of the coolant pipes used to be reduced, thereby lowering the structural weight of the propulsion system. Second, the original structure of the airplane can remain largely unchanged, which significantly simplifies integration in the airplane. The propulsion system integration can be achieved solely through modifications to the roof or wing, which may even allow a retrofit to an existing airplane type. Third, by placing the H2 tank on the roof, most of the hydrogen-carrying pipes can also be placed on top of the aircraft. In the event of a hydrogen leak, a safe leak path is ensured, as hydrogen rises upwards. This increases the safety of the overall system.

Installing the fuel store and the main heat exchanger on the underside of the fuselage may be disadvantageous compared to the present invention due to FOD risks (Foreign Object Damage, i.e. particles cast off from the nose landing gear).

Furthermore, the air can be directed via targeted air ducts through the cowl and around the pressure tanks, and then selectively exhausted at the end of the cowl. Various integration goals can be pursued here, such as the aerodynamic optimization of the airflow around the cowl (revitalizing “wake space areas”) or the targeted influencing of the airflow around the tail unit.

1. An aircraft having a fuel-cell propulsion system, wherein the fuel-cell propulsion system comprises:
at least one fuel cell configured and arranged to provide electrical supply of an electrical propulsion apparatus of the aircraft,
at least one fuel store configured and arranged to store fuel for the fuel cell, and
at least one cooling apparatus configured and arranged to cool the fuel cell and having a main heat exchanger, wherein
the main heat exchanger of the cooling apparatus and the at least one fuel store are arranged on a top side of a fuselage of the aircraft, and
the main heat exchanger is arranged on a nose side in front of the fuel store.

2. The aircraft according to claim 1, wherein the main heat exchanger and the fuel store are compactly arranged next to one another as an aerodynamic unit.

3. The aircraft according to claim 1, wherein a streamlined cowl encloses both the main heat exchanger and the fuel store.

4. The aircraft according to claim 3, wherein the cowl has an inlet opening and is configured and arranged to admit ambient air into the main heat exchanger and an outlet opening for discharging the ambient air from the cowl.

5. The aircraft according to claim 4, wherein the outlet opening is arranged in a discharge region of ambient air flowing around the cowl.

6. The aircraft according to claim 4, wherein the outlet opening is configured and arranged so ambient air discharged from the outlet opening promotes a flow around a tail unit of the aircraft.

7. The aircraft according to claim 4, wherein an air duct which fluidly connects, within the cowl, an outlet of the main heat exchanger with the outlet opening of the cowl.

8. The aircraft according to claim 1, wherein the fuel store has two cylindrical pressure tanks, wherein a main extension direction of each is substantially parallel to a longitudinal axis of the aircraft, wherein the two cylindrical pressure tanks are arranged next to one another along the main extension direction.

9. The aircraft according to claim 1, wherein the cooling apparatus has a secondary heat exchanger which is arranged in a downwash region of a propeller of the aircraft.

10. The aircraft according claim 1, wherein a liquid cooling medium of the cooling apparatus is configured and arranged to absorb waste heat from the fuel cell and to dissipate it to ambient air within the main heat exchanger.
